(19) United States
(12) Patent Application Publication
(10) Pub. No.: US 2017/0220179 A1
(43) Pub. Date: Aug. 3, 2017

(54) CROSS DEVICE GESTURE DETECTION

(71) Applicant: Nanoport Technology Inc., Markham (CA)

(72) Inventor: Timothy Jing Yin SZETO, Markham (CA)

(73) Assignee: Nanoport Technology Inc.

(21) Appl. No.: 15/175,814

(22) Filed: Jun. 7, 2016

Related U.S. Application Data
(60) Provisional application No. 62/289,015, filed on Jan. 29, 2016.

(51) Int. Cl. G06F 3/041; G06F 3/0488; G06F 3/14

(52) U.S. Cl. CPC G06F 3/0416; G06F 3/1423; G06F 3/0488

(57) ABSTRACT

A first electronic device comprising a plurality of connectors is disclosed. The device detects that at least one connector of a second electronic device has been connected to at least one of its connectors of the first electronic device. The first device determines that the second electronic device is in an identified position proximate the first electronic device, the identified position being one of a plurality of possible positions for connecting with the first electronic device, the possible positions being defined by the plurality of connectors of the first device. The first electronic device detects a gesture on its sensing surface. The gesture includes a swipe between a first position proximate the second electronic device and a second position, and is detected to extend across a confirmation boundary on the sensing surface. In response to detecting the swipe extending across the confirmation boundary, an indication confirming an inferred gesture across the first and second device is provided.

### CROSS-REFERENCE TO RELATED APPLICATIONS

This application claims the benefit of U.S. Provisional Application No. 62/289,015, filed Jan. 29, 2016, the entire contents of which are hereby incorporated by reference.

### TECHNICAL FIELD

This relates to touch-based user interfaces, and more particularly to touch gestures.

### BACKGROUND

Gesture man-machine interfaces involve detection of defined motions made by a user, with each of these various motions, or gestures, having an associated user-interface semantic.

Gestures may be detected in various ways. For example, if a device has a touch sensitive surface such as a touch screen or a touchpad, gestures may be input, for example, by a user using the user's fingers on the surface.

Co-pending, co-owned U.S. Provisional Patent Application No. 62/332,215, the entire contents of which are hereby incorporated by reference, discloses a technique for form-verified communication as may be used, for example, to communicate a request from a first device to a second device upon detecting a touch input that may span two devices.

Challenges arise in processing such gestures. For example, one challenge may be ensuring that a user intends to make an authorized cross-device request. Notably, a mistaken interpretation of request could result in an inadvertent security vulnerability as resources of one device may be exposed to the other device despite a lack user intention to make or authorize such a request.

As disclosed in the U.S. Patent Application No. 62/332,215, one way to ensure that a cross-device requested is intended is to verify that two devices are physically proximate—e.g. mechanically joined at touching edges and that a cross-device gesture crosses an interconnected edge. For example, verification of a mechanical connection may involve detection of a connection between the devices formed using magnetic connectors as disclosed in co-pending, co-owned U.S. Provisional Patent Application No. 62/327,826, the contents of which are hereby incorporated by reference.

### SUMMARY

Novel ways of ensuring that a user intends to make a cross-device request are disclosed. These may be used independently of, or in addition to, other methods of determining user intent.

In an aspect, there is provided a method comprising: at a first electronic device comprising a plurality of connectors: detecting that at least one connector of a second electronic device has been connected to at least one of the plurality of connectors of the first electronic device; determining that the second electronic device is in an identified position proximate the first electronic device, the identified position being one of a plurality of possible positions for connecting with the first electronic device, the possible positions being defined by the plurality of connectors of the first device; detecting at the first electronic device, a gesture on a sensing surface of the first device, the gesture comprising a swipe between a first position proximate the second electronic device and a second position, detecting the swipe extending across a confirmation boundary on the sensing surface; and in response to the detecting the swipe extending across the confirmation boundary, providing an indication confirming an inferred gesture across the first and second device.

Conveniently, in this way the ability of an electronic device to interact with the user may be improved.

In an aspect, there is provided a non-transitory computer readable medium storing instructions that when executed by a processor of a first electronic device comprising a plurality of connectors, cause the device to: detect that at least one connector of a second electronic device has been connected to at least one of the plurality of connectors of the first electronic device; determine that the second electronic device is in an identified position proximate the first electronic device, the identified position being one of a plurality of possible positions for connecting with the first electronic device, the possible positions being defined by the plurality of connectors of the first device; detect at the first electronic device, a gesture on a sensing surface of the first device, the gesture comprising a swipe between a first position proximate the second electronic device and a second position, detect the swipe extending across a confirmation boundary on the sensing surface; and in response to detecting the swipe extending across the confirmation boundary, provide an indication confirming an inferred gesture across the first and second device.

In another aspect, there is provided an electronic device comprising a touch-sensitive surface; a processor in communication with the touch-sensitive surface; a plurality of connectors; a non-transitory computer-readable medium coupled to the processor and storing instructions that when executed by the processor cause the device to: detect that at least one connector of a second electronic device has been connected to at least one of the plurality of connectors of the first electronic device; determine that the second electronic device is in an identified position proximate the first electronic device, the identified position being one of a plurality of possible positions for connecting with the first electronic device, the possible positions being defined by the plurality of connectors of the first device; detect at the first electronic device, a gesture on a sensing surface of the first device, the gesture comprising a swipe between a first position proximate the second electronic device and a second position, detect the swipe extending across a confirmation boundary on the sensing surface; and in response to detecting the swipe extending across the confirmation boundary, provide an indication confirming an inferred gesture across the first and second device.

### BRIEF DESCRIPTION OF THE DRAWINGS

Embodiments are described in detail below, with reference to the following drawings.

FIG. 1 is a plan view of an electronic device illustrating the operating environment of an embodiment.

FIG. 2 is a high-level block diagram of the electronic device of FIG. 1, exemplary of an embodiment.

FIG. 3 illustrates the software organization of the electronic device of FIG. 1;

FIG. 4 is a plan view of the electronic device of FIG. 1 adjacent to a similar device to which It may be mechanically joined, illustrating the operating environment of an embodiment;

FIG. 5 is a flow diagram illustrating the operation of the software of FIG. 3;

FIG. 6 is a further view of the electronic devices of FIG. 4 illustrating an interaction gesture, exemplary of embodiments;

FIG. 7 is a further view of the electronic devices of FIG. 4 illustrating an alternate interaction gesture, exemplary of embodiments;

FIG. 8 is a further view of the electronic devices of FIG. 4 illustrating screen displays thereon, exemplary of embodiments;

FIG. 9 is a further view of the electronic devices of FIG. 4 illustrating example updated screen displays further to user interaction;

FIG. 10 is a further view of the electronic devices of FIG. 4 illustrating an interaction gesture, exemplary of embodiments;

FIG. 11 is a further view of the electronic devices of FIG. 4 illustrating an alternate interaction gesture, exemplary of embodiments;

FIG. 12 is a further view of the electronic devices of FIG. 4 illustrating an example screen display for obtaining user confirmation of user intention;

FIG. 13 is a further view of the electronic devices of FIG. 4 illustrating multiple interaction gesture confirmation thresholds, exemplary of embodiments;

FIG. 14 is a further view of the electronic devices of FIG. 4 illustrating an example screen display for obtaining user confirmation of user intention;

FIG. 15 is a plan view of the electronic device of FIG. 1 and a touch sensitive electronic device without a display, illustrating the operating environment of an embodiment;

FIG. 16 is a plan view of the electronic devices of FIG. 15 mechanically joined, further illustrating the operating environment of an embodiment;

FIG. 17 is a further view of the electronic devices of FIG. 16 illustrating an interaction gesture, exemplary of embodiments;

FIG. 18 is a plan view of the electronic device of FIG. 1 mechanically connected to a non-touch sensitive electronic device, illustrating the operating environment of an embodiment; and

FIG. 19 is a further view of the electronic devices of FIG. 18, illustrating an interaction gesture, exemplary of embodiments.

### DETAILED DESCRIPTION

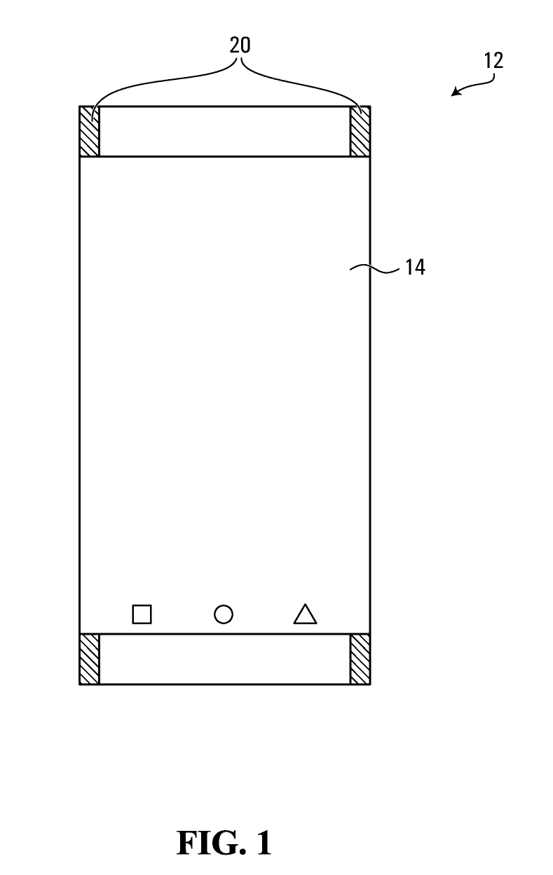

FIG. 1 is a plan view of an electronic device illustrating the operating environment of an embodiment.

As illustrated, electronic device 12 includes a sensing surface in the form of a touch screen display 14 and includes mechanical connectors 20 for interconnecting a proximate device.

Electronic device 12 is illustrated as a smartphone, however this is by no means limiting. Instead, as will become apparent, electronic device 12 may be any suitable computing device such as, for example, a smartphone, a tablet, a smart appliance, a peripheral device, etc.

Touch screen display 14 may, for example, be a capacitive touch display, a resistive touch display, etc. Touch screen display 14 may include a display element and a touch sensing element integrated as a single component. Alternatively, touch screen display 14 may include suitably arranged separate display and touch components. Touch screen display 14 may be adapted for sensing a single touch, or alternatively, multiple touches simultaneously. Touch screen display 14 may sense touch by, for example, fingers, a stylus, or the like.

As illustrated, magnetic connectors 20 of electronic device 12 permit electronic device 12 to be mechanically coupled to other suitable devices. An example of a possible magnetic connector is described in International Patent Application Publication No. WO 2015/070321 and U.S. Pat. No. 9,312,633. Each connector 20 may mechanically and, optionally, electrically couple one device to another. For example, a USB 2.0/3.0 bus may be established through the electrical connection achieved by connector 20.

Additionally or alternatively, electronic device 12 may have non-magnetic connectors for mechanical and/or electrical coupling with other suitable devices.

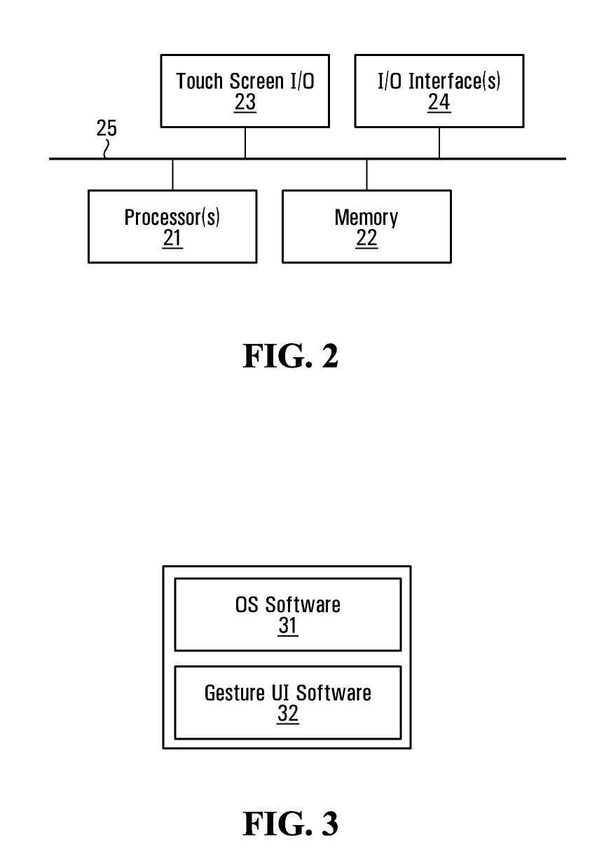

FIG. 2 is a simplified block diagram of the electronic device of FIG. 1, exemplary of an embodiment.

As illustrated, electronic device 12 includes one or more processors 21, a memory 22, a touch screen I/O interface 23 and one or more I/O interfaces 24, all in communication over bus 25.

One or more processor(s) 21 may be one or more Intel x86, Intel x64, AMD x86-64, PowerPC, ARM processors or the like, and may include a single or multiple processing cores. In some embodiments, processor(s) 21 may be mobile processors and/or may be optimized to minimize power consumption if, for example, electronic device 12 is battery operated.

Memory 22 is computer readable memory and may include random-access memory, read-only memory, or persistent storage such as a hard disk, a solid-state drive or the like. A computer-readable medium may be organized using a file system, controlled and administered by an operating system governing overall operation of the computing device.

Touch screen I/O interface 23 serves to interconnect the computing device with touch screen display 14. Touch screen I/O interface 23 is adapted to allow rendering images on touch screen display 14. Touch screen I/O interface is also operable to sense touch interaction with one or more computer networks such as, for example, a local area network (LAN) or the Internet.

One or more I/O interfaces 24 may serve to interconnect the computing device with peripheral devices, such as for example, keyboards, mice, and the like. Optionally, network controller 23 may be accessed via the one or more I/O interfaces.

Software including instructions is executed by processor(s) 21 from a computer-readable medium. For example, software may be loaded into random-access memory from persistent storage of memory 22 or from one or more devices via I/O interfaces 24 for execution by one or more processors 21. As another example, software may be loaded and executed by one or more processors 21 directly from read-only memory.

FIG. 3 depicts a simplified organization of example software components stored within memory 22 of electronic device 12. As illustrated these software components include operating system (OS) software 31 and gesture UI software 32.

OS software 31 may be, for example, Android OS, Apple iOS, Microsoft Windows, UNIX, Linux, Mac OSX, or the like. OS software 31 allows software 32 to access one or more processors 21, memory 22, touch screen I/O interface 23, and one or more I/O interfaces 24 of electronic device 12.

OS software 31 may provide an application programming interface (API) to allow the generation of graphics on touch screen 14. Likewise, OS software 31 may generate message representative of sensed input at interface 14. Gesture UI software 32 adapts electronic device 12, in combination with OS software 31, to provide a gesture enabled user interface (UI).

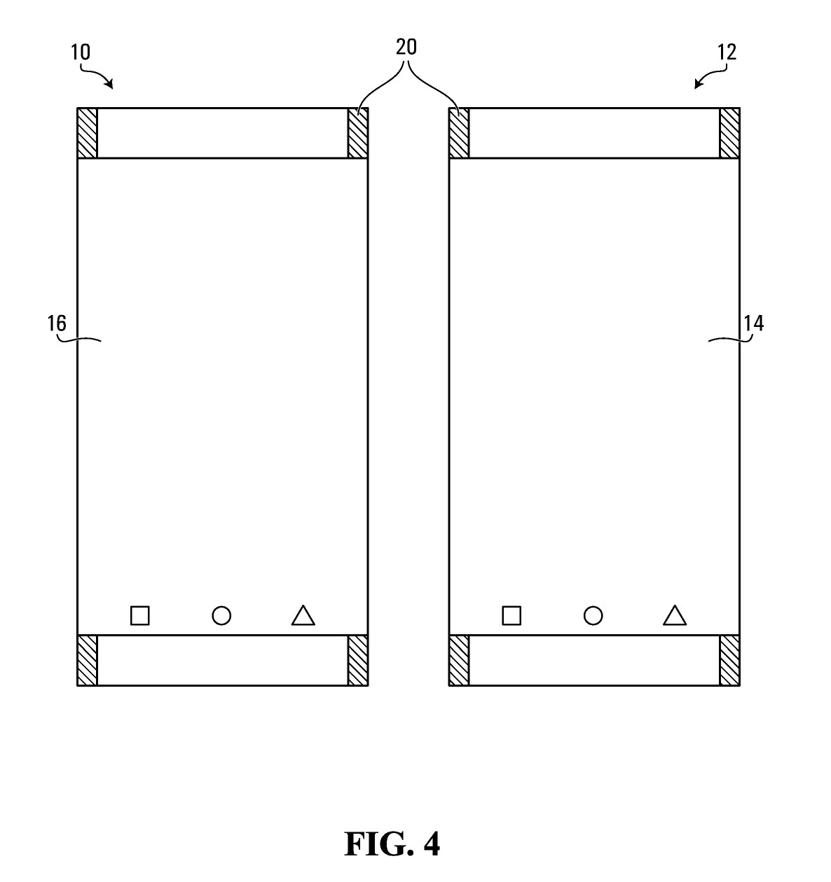

FIG. 4 is a plan view of the electronic device of FIG. 1 adjacent to a similar device to which It may be mechanically joined, illustrating the operating environment of an embodiment;

Second electronic device 10 is similar or identical to electronic device 12. Second electronic device has magnetic connectors 20 and a touch screen 16.

Electronic device 12 and second electronic device 10 may be mechanically coupled by way of magnetic connectors 20. As noted above, magnetic connectors may optionally offer an electrical connection.

Optionally, electronic device 12 and second electronic device 10 may communicate wirelessly, in which case connectors 20 need not, but still may, establish an electrical connection. Wireless communication may be, for example, by way of an 802.11x connection or, additionally or alternatively, using another technology such as, for example, Zigbee, Bluetooth, TransferJet, or the like.

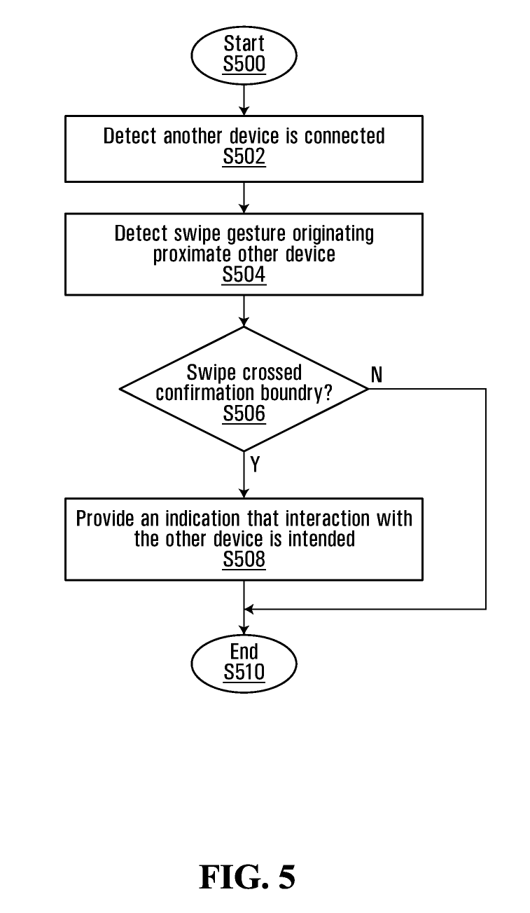

The operation of gesture UI software 32 is described with reference to the flowchart of FIG. 5. Blocks S500 and onward are performed by one or more processors 21 executing software 32 at electronic device 12.

Block S500 denotes the start of the flow diagram.

At block S502, processor(s) 21 of device 12 detect that another device is connected and the relative spatial relationships of the devices may be determined. For example, in some embodiments, processor(s) 21 may receive an indication such as, for example, over bus 25 that another electronic device, such as second electronic device 10, is mechanically connected to electronic device 12 by way of mechanical connectors 20. Methods of detecting a connection state may be utilized such as, for example, as disclosed in above-noted U.S. Provisional Patent Application No. 62/327,826.

Additionally, a communications link may be established between electronic device 12 and the connected device, for example, by way of magnetic connectors 20 as discussed above. For example, a USB bus may established between device 10 and 12, as detailed in International Patent Application Publication No. WO 2015/070321 and U.S. Pat. No. 9,312,633. Additionally or alternatively, a wireless communications link may be established such as is discussed above.

Relative spatial positions of the devices may be detected such as, for example, according to the engaged connectors of device 12 and or other electronic device. For example, devices may determine spatial relationships with interconnected devices such as according to the disclosure in co-pending, co-owned U.S. patent application Ser. No. 15/013,750 and U.S. Provisional Patent Application No. 62/332,215, the contents of which are herein incorporated by reference. Briefly, device 12 may determine the relative position of device 10, by determining which connector of device 12 is connected to device 10. This determination may be made when device 12 is connected to device 10, or at any other suitable time. Based on the known position of this connector 20, device 12 may deduce the relative position of device 10 relative to device 12, as one of a plurality of possible positions for connecting with electronic device 10 to device 12. The possible positions are each defined by the location of one of the plurality of connectors 20 device 12 (e.g. top, bottom, right side, left side, etc.). The relative location of device 12 to device 10 may be stored in an appropriate data store in memory 22 of device 12, and optionally communicated to device 10 or other devices.

At block S504, a swipe gesture is detected originating at a region of touch screen display 14 proximate the other connected electronic device.

A swipe gesture may be detected as a first detection of a touch caused by an implement such as a finger, stylus, or the like touching down on touch screen 14. The gesture may continue, without lifting the implement, with the implement pulled across touch screen 14 in contact therewith, thereby tracing a path across touch screen 14 before being lifted off touch screen 14 at a second point, the lift off may also be part of the gesture—and detected. Processor(s) 21 may receive indications of all of these events such as, for example, over bus 25 from touch screen I/O interface 23. In some embodiments, multiple indications may be received or generated corresponding to each event. For example, a gesture may result in a series of touch events, each of which may be detected, and the collection of touch events, where appropriate, may be interpreted as a gesture. Multiple touch events may result in the generation of a message indicative of the gesture.

Alternatively, the swipe gesture may start with contact outside the touch sensitive area of the display such as for example, on the screen of the other connected device (e.g. device 10) or on a bezel of electronic display 12. In such cases, processor(s) 21 of device 12 may not receive any indication of the implement touching down and may only receive indication of the implement being pulled across touch screen 14. Alternatively, an indication may be received that a touchdown occurred at an appropriate position along the extreme edge of touch screen 14 of device 12.

Additionally or alternatively, the swipe gesture may end with contact outside the touch sensitive area of the display such as for example on a bezel of electronic display 12. In such cases, processor(s) 21 may not receive any indication of the implement lifting off and may only receive indication of the implement being pulled across touch screen 14. Alternatively, an indication may be received that a lift off occurred at an appropriate position along the extreme edge of touch screen 14.

In some embodiments, electronic device 12 may receive an indication such as, for example, by way of the communication link of a first portion of the gesture detected by the other electronic device 10. The communication may, for example be a message passed along any electrical or other communication interconnection between devices 10 and 12. Optionally, electronic device 12 may perform steps to ensure that the portion of the gesture performed/sensed on it complements the portion of the gesture performed on the other electronic device 10. For example, software may be executed to ensure that the portions are spatially aligned such as in, for example, a single gesture spanning the two devices. For example, if electronic device 12 is coupled to second electronic device 10, the devices may communicate to determine whether a single gesture spans touch screen display 14 of device 12 and touch screen display 16 of device 10.

At block S506, a determination may be made whether the swipe gesture passed a confirmation threshold on second device 12.

As will become apparent, a confirmation threshold may be a notional line spanning touch screen 14 of second device 12. Alternatively, a confirmation threshold may be a notional arc or other shape defining a boundary.

Confirmation threshold serves to effectively partition touch screen 14 of device 12 into two regions. The gesture trigger a response if it crosses the confirmation threshold on device 12, from one region to the other.

In some embodiments, the length of the gesture may be determined and the gesture may be considered to traverse the confirmation threshold if it exceeds a threshold length. Such a length evaluation may be performed in addition to or in alternative to evaluation of whether the swipe spans the confirmation threshold and/or evaluations of the relative locations of the liftoff and touchdown portions of the gesture.

If the gesture is detected to cross the confirmation boundary, the gesture may trigger a response and control flow proceeds to block S508. Alternatively, if the gesture is not so detected, control flow may terminate at block S510.

In some embodiments, the shape of the path traced across touch screen 16 of device 10 or screen 14 of device 12 may be evaluated to determine whether the gesture is to trigger a response. For example, the gesture may only trigger a response if the path is effectively straight or arcuate and may not be detected if, for example, the path is excessively “wiggly” or if it forms “loops” or other closed shapes, etc. The path may be assessed by analyzing touch events associated with each gesture.

At block S508, an indication is provided confirming the interaction across devices, and that interaction with the other device is intended. The indication may, for example, be a message, setting of a semaphore, or other software indication that the operating system or an application executing at device 10 or device 12, may use in further processing the detected gesture.

As will be appreciated, use of the confirmation threshold in conjunction with detecting a gesture proximate device 10, allows device 12 to infer a cross-device gesture, without further user interaction with device 10.

In some embodiments, device 12 may also retrieve data associated with the gesture from device 10, such as, for example, as may be indicative of what resources are being requested. Such data may be retrieved, for example, in manners disclosed in co-pending, co-owned U.S. Provisional Patent Application No. 62/332,215.

In some embodiments, providing an indication may include initiation of the interaction with other device 10.

Alternatively, further confirmation may be obtained that interaction is intended. Further confirmation may be obtained, for example, by way of a suitable user interface presented at device 12 or device 10. The user interface may include a confirmation dialog, check box input or the like.

Following block S508, control flow for the gesture detection proceeds to terminate at block S510.

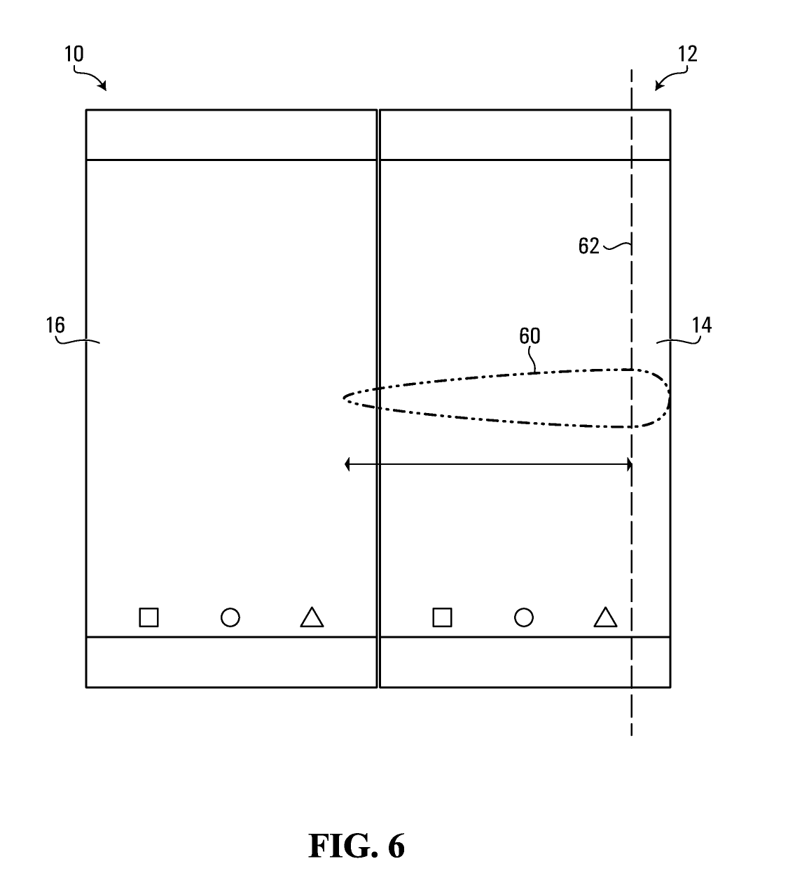

FIG. 6 is a further view of the electronic devices of FIG. 4 illustrating an interaction gesture, exemplary of embodiments,

As illustrated a gesture 60 starts on touch screen 16 of device 10 and continues across it. Notably, gesture 60 extends past a confirmation threshold 62. As discussed, a gesture spanning confirmation threshold 62 may be taken as an indication of the user's intent to make a cross-device request.

Confirmation threshold 62 is illustrated as a stippled line on screen 14 of device 12 and serves only to denote the division of areas. In some embodiments, however, a visual indication of confirmation threshold 62 may be provided to a user such as, for example, after mechanical connection with a second electronic device is detected or during gesture detection such as, for example, after touchdown detection and prior to lift off detection.

As illustrated, confirmation threshold is proximate the far edge electronic device 12. Electronic device 12 may calculate this confirmation threshold as a percentage of distance between the left and right edges of electronic device 12 or touch screen 14 such as, for example, 80% or 90%. This percentage could be 100%, thereby requiring the gesture to travel to the right edge of electronic device 12. Optionally, this threshold may be user selected, by way of a device setting or application selected.

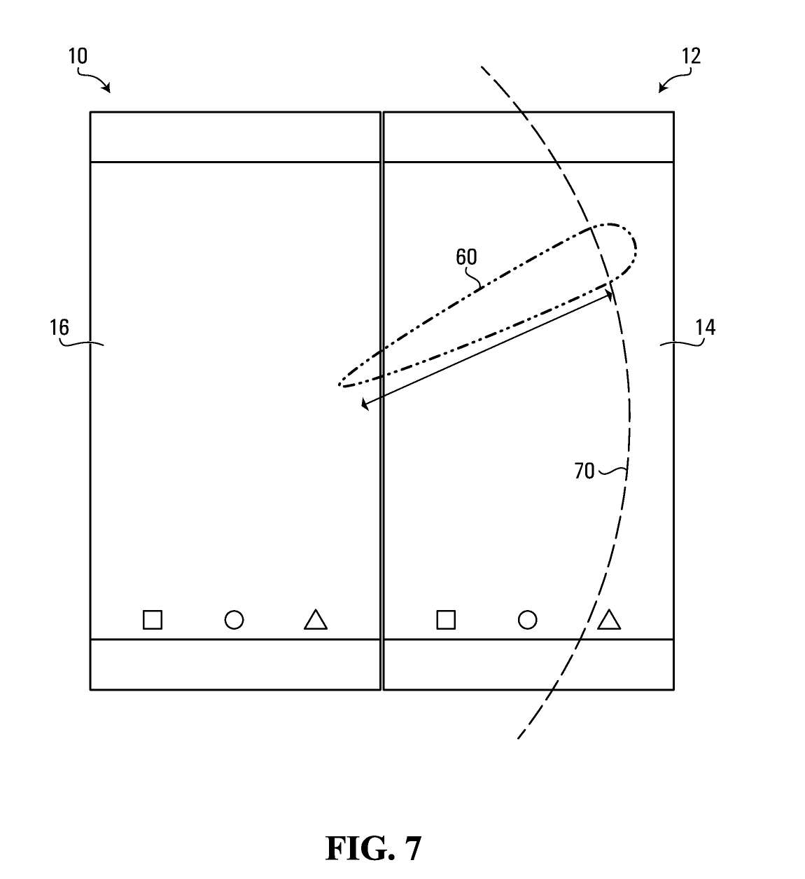

The confirmation threshold need not extend along a straight line, and need not be static. For example, the threshold may be an arc centered and sized in dependence on each gesture. For example, an arcuate confirmation threshold 70 may be defined by the locus of points a fixed distance from the starting position of gesture 60 as shown in FIG. 7. Alternatively, arcuate confirmation threshold 70 may be defined by the locus of points a fixed distance from another suitable point such as, for example, the first position of gesture 60 on device 12.

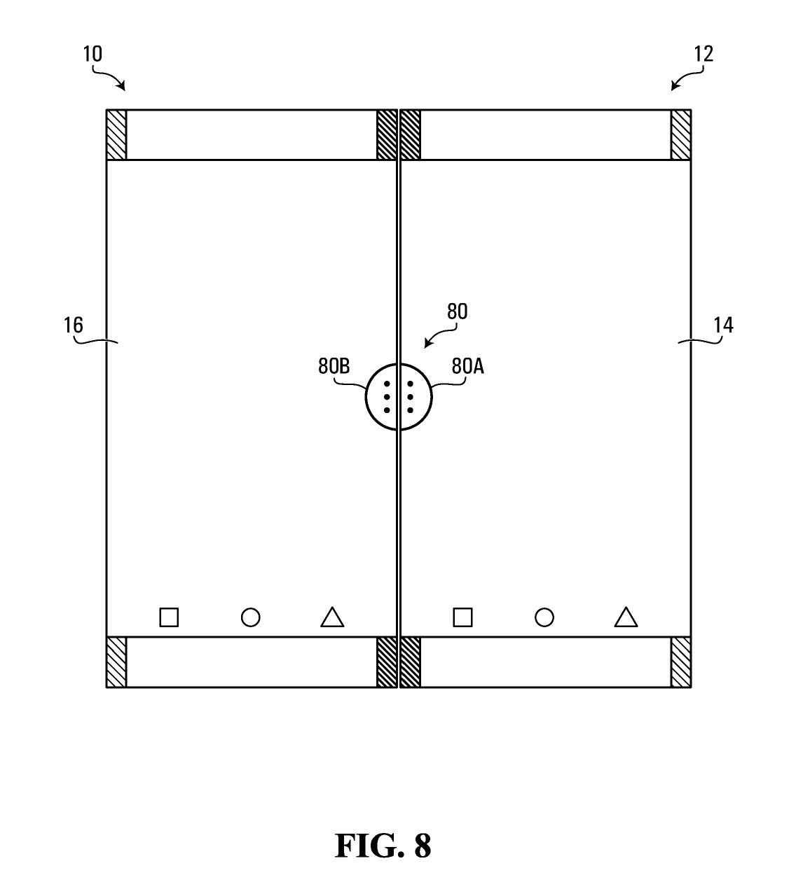

FIG. 8 is a further view of the electronic devices of FIG. 4 illustrating screen displays, exemplary of embodiments.

Each of devices 10 and 12 may determine its relative spatial position to the other device. For example, each may determine its relative spatial position to the other device in manners described in co-owned U.S. patent application Ser. No. 15/013,750, the entire contents of which are herein by reference.

As illustrated, each of devices 10 and 12 may under software control, upon detecting its relative spatial position to the other, display an indicator on its respective screen—i.e., indicator 80A on touch screen 14 of device 12 and indicator 80B on touch screen 16 of device 10.

Indicators 80A and 80B form a cross-device request button (referred to as button 80) on the user interfaces of device 10 and 12, that may be manipulated by the user to initiate a request, as described below.

To present button 80, each device 10, 12 calculates an appropriate location to display its respective portion of button 80 (i.e. one of indicators 80A/80B) based on the determined relative spatial position of the device to the other device, so that button 80 appears to straddle the touching edges of the devices. For example indicators 80A/80B may, as illustrated, be displayed such that the request button is vertically centred along the touching edges.

In placing indicators 80A/80B, each device may take into account any differences in pixel resolution, pixel pitch between touch screens 14 and 16 so that indicators 80A and 80B are aligned and match in size. To that end, software at each of devices 10, 12 may calculate a size in pixels for indicator 80A and 80B that will result in the indicators of the same pre-defined absolute dimensions (i.e. in cm) on each device 10, 12.

Conveniently, in this way, a specific location to be touched by the user to begin a cross-device gesture to initiate a cross-device request may be visually indicated. Notably, the cross-device gesture may only be detected where it begins somewhere in the area denoted by button 80.

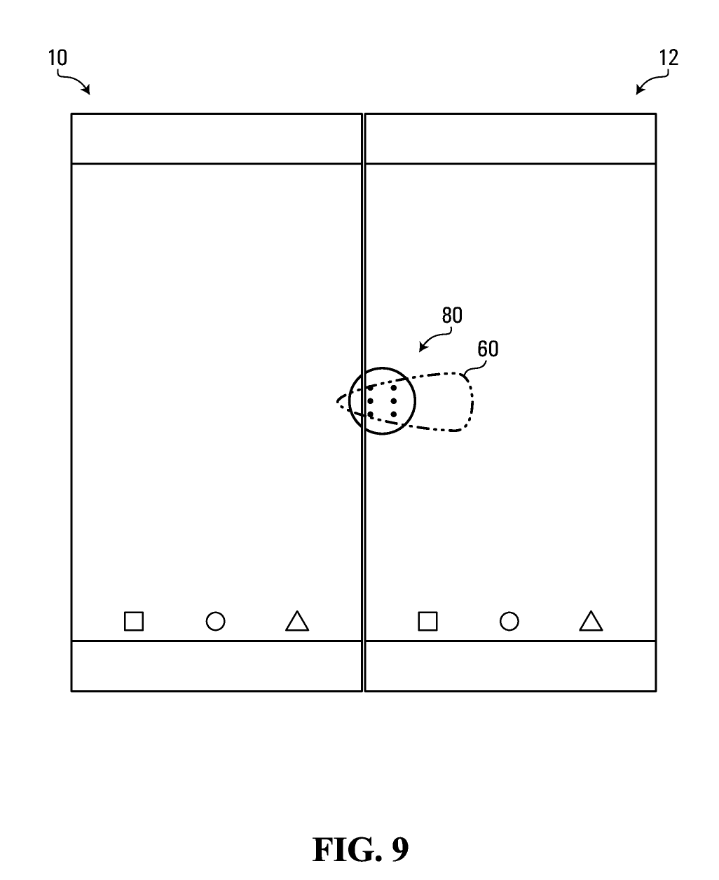

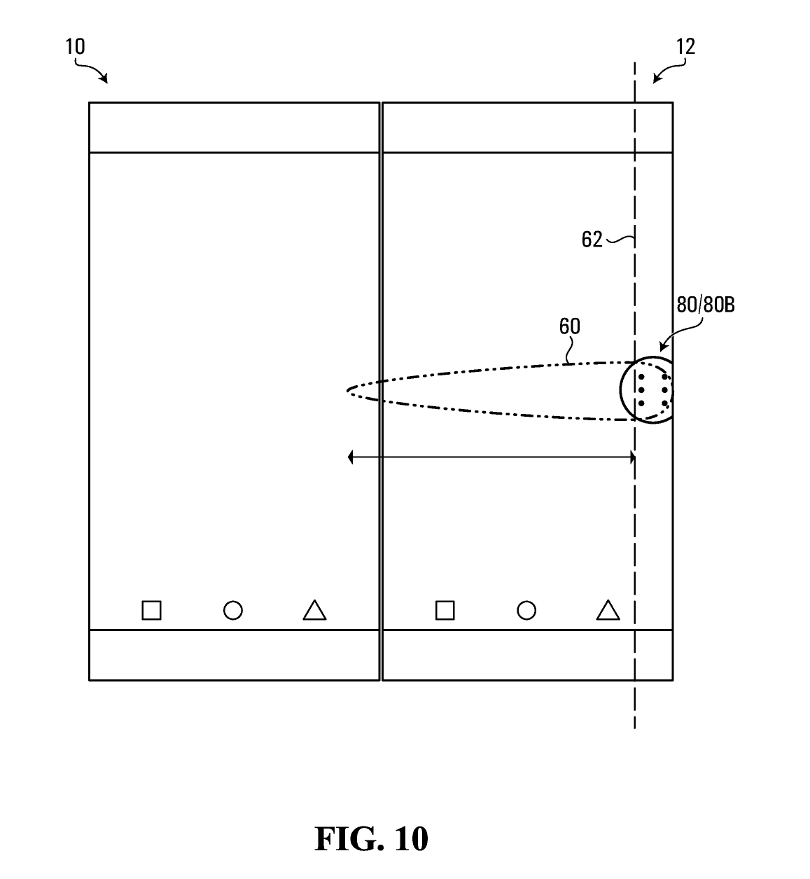

FIG. 9 and FIG. 10 each illustrate an example of how the screen display of button 80 on each of devices 10, 12 may be updated during a gesture interaction.

As illustrated in FIG. 9, a gesture 60 may begin at the right edge of device 10, at the initial position of button 80, and then progresses past the left edge of device 12. Devices 10 and 12, based on the touch input sensed at each of those devices, update each of indicators 80A and 80B so as to depict movement of button 80 from its initial position rightward, tracking the user's touch. In other words, button 80 is drawn at each of device 10, 12 so as to appear to be dragged by the user and more specifically, by the user interaction with touch screens 14 and 16. As button 80 is dragged away from device 10 toward device 12, device 10 may update its user interface as presented on its display 16 to reflect the movement of indicator 80A. As the dragging continues, device 12 may generate one or more messages that may be received at device 10. In response to receiving the messages, software at device 10 may further update its user interface as presented on its display 16 to reflect the further movement and eventual disappearance of indicator 80A. As well, the shape of indicator 80B may be varied at device 12 to reflect a transition from a button half (e.g. depicted in the embodiment as a semi-circle) to a full button (e.g. depicted in the embodiment as a full circle).

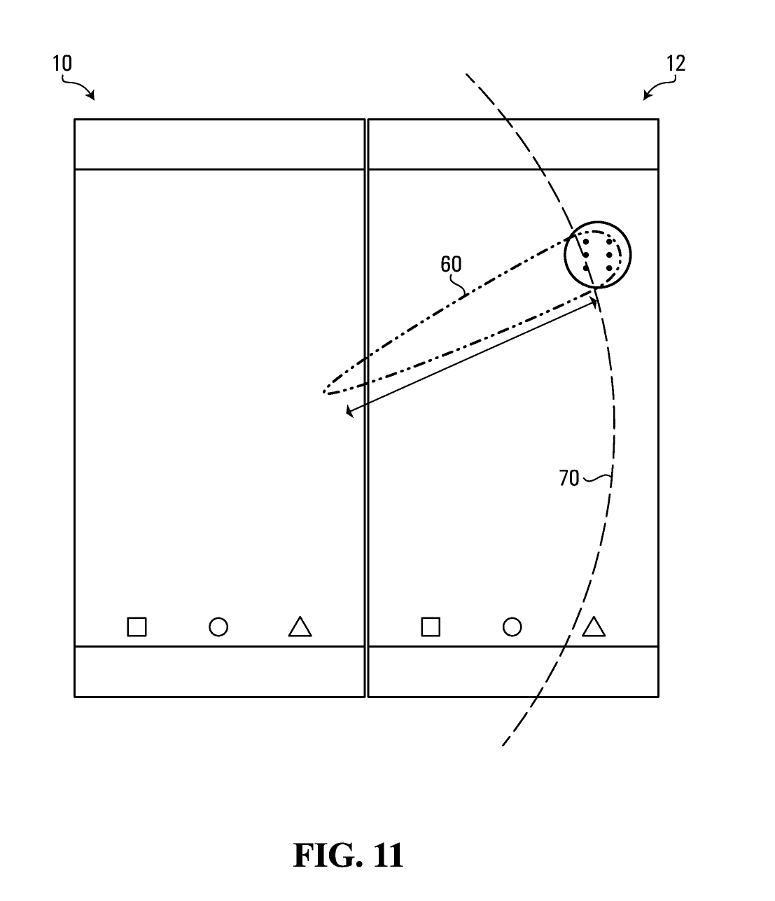

FIG. 10 shows gesture 60 extending further rightward, and corresponding movement of button 80. As will be appreciated, once gesture 60 passes the right edge of device 12, device 12 ceases to display indicator 80A and the entirety of button 80 is displayed as indicator 80B on device 12. Once the gesture guiding button 80 crosses a confirmation threshold, an appropriate indicator may be generated. As discussed above, a confirmation threshold need not extend along a straight line. FIG. 11 illustrates a confirmation threshold 70 that is arcuate. In particular, confirmation threshold 70 may be defined by a circular arc that is a chosen distance from a position within the region defined by indicator 80 in its initial position, prior to the start of user input of gesture 60.

As illustrated, indicator 80 has points therein such as may appear tactile and may suggest touch interaction is supported. This is by no means required. For example, indicator 80 may be otherwise shaded, colored, etc.

As illustrated, indicator 80 is round and formed of symmetrical indicators 80A and 80B, but this is by way of example only and is by no means limiting. For example indicator 80 could be another shape such, as for, example a square or a heart. In another example, indicator 80 may be formed of asymmetrical indicators such as, for example, if indicator 80 is a shape such as, for example, a logo.

As discussed above, upon detection of gesture, user intention optionally may be further confirmed. For example, confirmation may be by way of a suitable GUI, presenting a dialog box or the like.

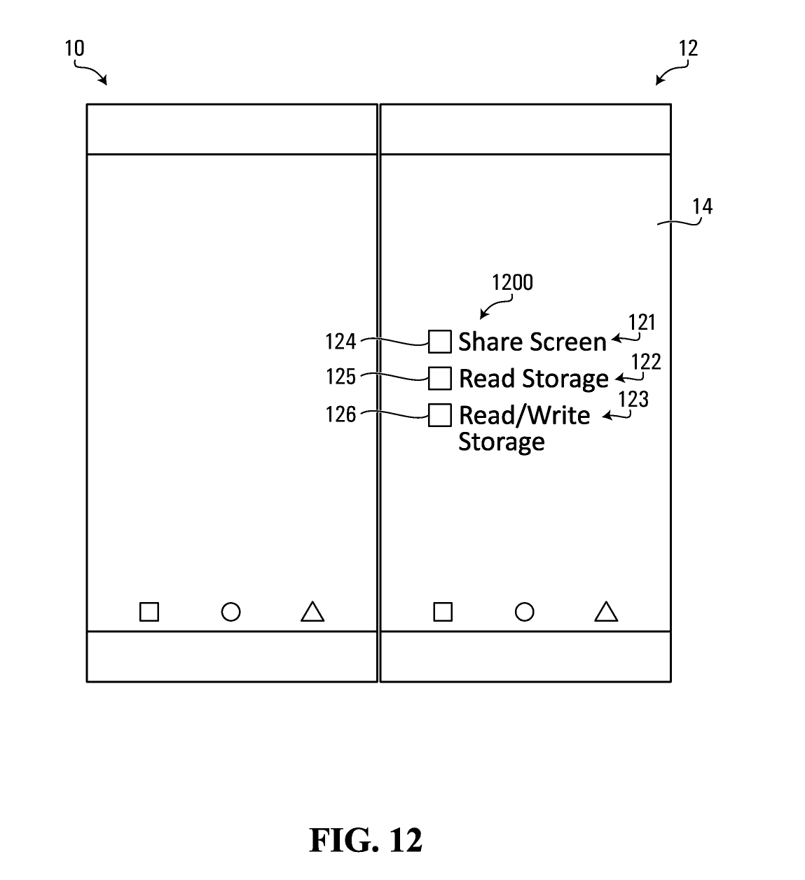

FIG. 12 illustrates an example screen display for obtaining user confirmation of user intention.

As illustrated, example requests 121, 122, 123 made by device 10 to device 12 may include access to display content to the screen of device 12 (item 121), to read from the storage of device 12 (item 122), to read from/write to the storage of device 12 (item 123), etc. The illustrated requests are by no means exhaustive—many other types of requests are possible, such as, for example, to pair the devices or to access other types of resources at the device.

Presented with the display of FIG. 12, the user may then confirm the request to one or more of the resources by touch input on touch screen 14 of device 12.

For example, a user may populate one or more of checkboxes 124, 125, 126 to indicate that a corresponding one of items 121, 122, 123 is confirmed.

As noted above, device 12 optionally receive a communication from device 10 indicating that a gesture has been detected starting on device 10. Additionally, that communication may include requests such as those illustrated in FIG. 12. Alternatively, multiple communications may be sent. Such communications may be close or distant in time. For example, they may both be sent prior to the start of gesture input. Alternatively, the requests may be pushed to device 12, such as, for example, in response to a request made after the start, or even completion, of the user input of the gesture.

Alternatively, device 12 may detect a confirmation gesture prior to receiving a request from device 10. For example, where device 12 maintains a resource request queue such that disclosed in U.S. Patent Application No. 62/332,215.

In some embodiments, no communication may be received from the other device where a user does not interact with that display or inadvertently fails to touch the initial gesture position on that device such as, for example, as may be indicated in some embodiments by indicator 80A. In some embodiments, such a gesture may be discarded as not indicative of a user intention to initiate a cross-device request. Alternatively, device 12 may transmit a message (directly or via an intermediary) to device 10 to retrieve a set of pre-defined or default requests for processing at device 12.

As noted above, a user may choose to allow a request for, for example, read of storage, while not approving a request for read/write storage such as by way of a confirmation user interface.

Additionally or alternatively, a user may indicate intention as between allowing a) a less intrusive request, such as, for example, read access to device storage, versus b) allowing a more intrusive request, such as, for example, read/write access to device storage, by way of variation in gesture.

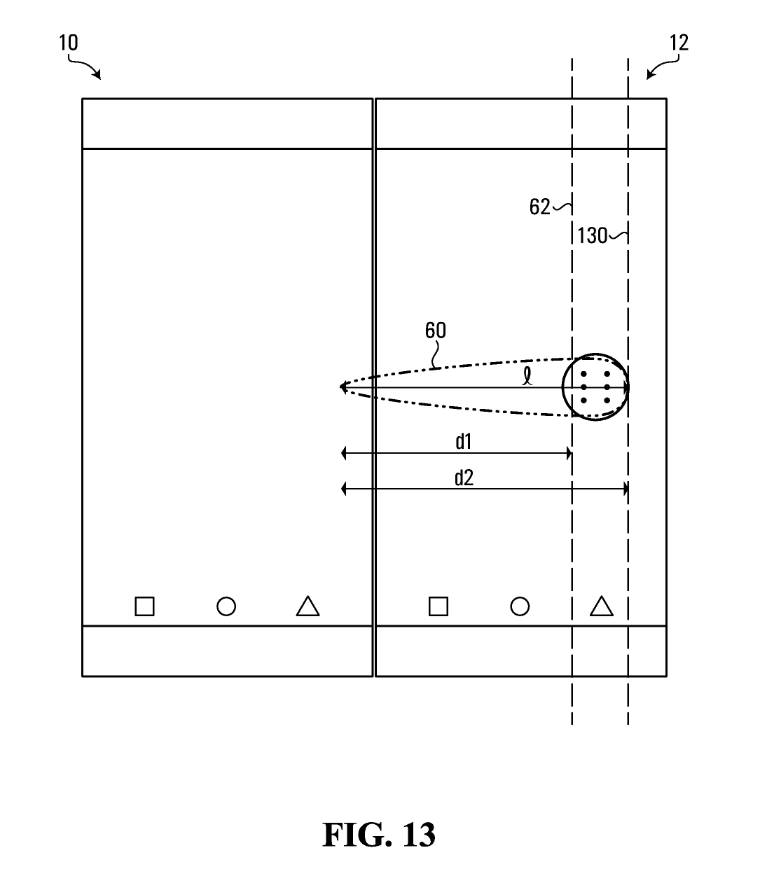

FIG. 13 illustrates embodiments that allow users to indicate such a differentiated intention by providing multiple interaction gesture confirmation thresholds.

As illustrated, a gesture 60 may be detected as one permitting a first level of access if it crosses confirmation threshold 62, but may be detected as one permitting a second level of access if it also crosses second confirmation threshold 130.

For example, if a gesture traversed only confirmation threshold 62 (and not second confirmation threshold 130—i.e. having a length/such that d1<l<d2) it may be interpreted as indicating intention to only allow a less intrusive request and not to allow the more intrusive request. Then, if instead a gesture traverses both confirmation threshold 62 and second confirmation threshold 130—i.e. having a length l such that l>d1>d2) it may be interpreted as indicating intention to allow the more intrusive requests. In some embodiments, the latter form of gesture (crossing both thresholds) may also be interpreted as an intention to also allow the less intrusive requests, though this is by no means required.

Notably, crossing the second further confirmation threshold is interpreted as an indication of an intention to allow more intrusive access to device 12, the length of gesture 60 is effectively correlated with the degree of access to grant. More particularly, as shown in FIG. 13, for less intrusive access, the gesture must be at least of length d₁, whereas for more intrusive access, the gesture must be at least of length d₂, where d₁<d₂. Conveniently, in this way, the association between the length of the gesture and the degree of access may be intuitive to a user.

Access may be considered more intrusive according to classifications as may be well-known to persons of ordinary skill. For example, write may be considered more intrusive than read. Additionally, the classification of intrusiveness may be more fine-grained, for example deleting data may be considered more intrusive than appending data. Additionally or alternatively, intrusiveness may correspond to access permissions such as, for example, operations requiring super-user or administrator access being considered more intrusive than those that can be performed by an ordinary user or even a guest user.

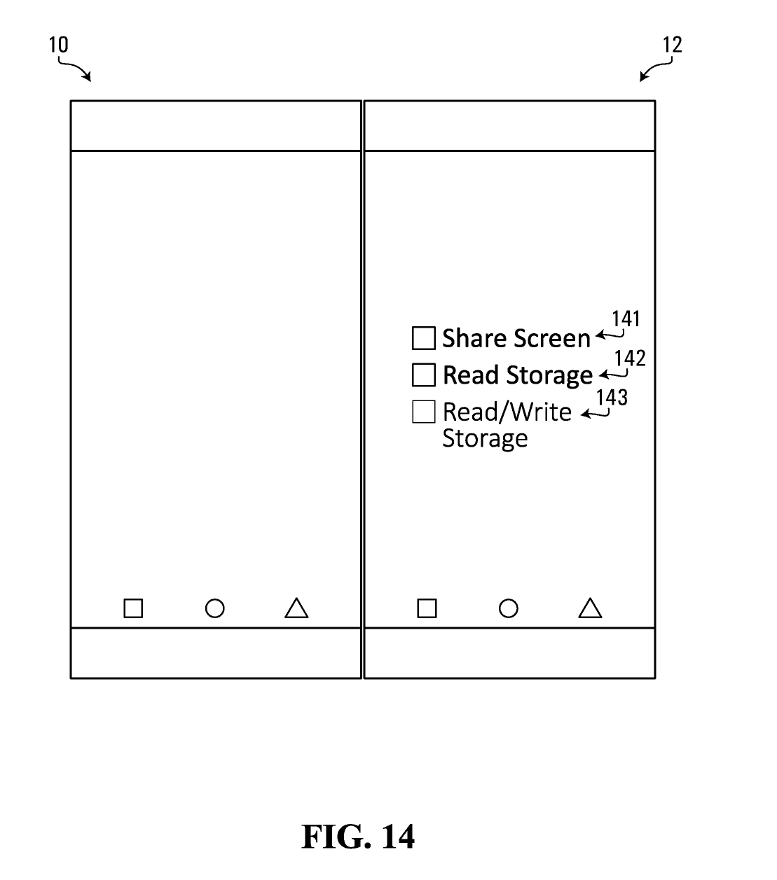

FIG. 14 illustrates an example screen display for obtaining user confirmation of user intention such as may be used, for example, to confirm a user's intention to granted a selected degree of access such as may have been indicated by gestures permitting intention to grant one of several differentiated levels of access, such as, for example, using the above described arrangement of multiple confirmation thresholds.

As illustrated, example requests 141, 142, 143 made by device 12 to device 12 may include access to display content to the screen of device 12 (item 141), to read from the storage of device 12 (item 142), to read from/write to the storage of device 12 (item 143), etc. The illustrated requests are by no means exhaustive—many other types of requests are possible, such as, for example, to pair the devices or to access other types of resources at the device.

Notably, in the illustrated example of FIG. 14 resources not requested, as determined based on for example, a gesture length, may be depicted on the screen of device 12. As shown, item 143 is greyed out while items 141, 142 is not, consistent with a user having indicated an intention not to grant the more intrusive read/write storage access of item 143.

In some embodiments, the requesting device may interact with a device without a display.

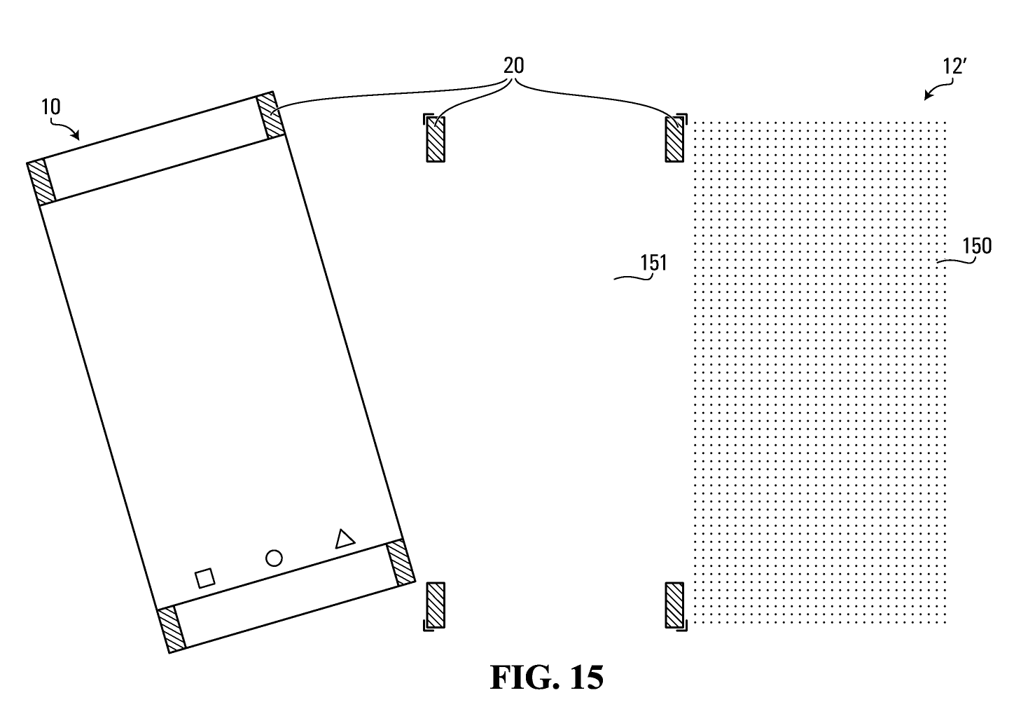

FIG. 15 is a plan view showing electronic device 10 and a touch sensitive electronic device 12′ without a display

As shown in FIG. 15, device 12′ may include a mounting location 151 for mounting device 10, and a touch sensitive region 150 adjacent to the mounting location.

As shown, mounting location 151 may include one or more magnetic connectors 20 for engaging magnetic connectors 20 of device 12.

Each of devices 10 and 12′ detects that device 10 has been received in mounting location 151 such that device 10 and device 12′ are at least mechanically, if not electrically, connected by way of their respective magnetic connectors 20.

Device 12′ may be integrated into a suitable system such as, for example, a vehicle dashboard. Conveniently, in this way, device 10 may connect with device 12′ and request access to various vehicle resources such as, for example, speakers, vehicle sensors, and the like.

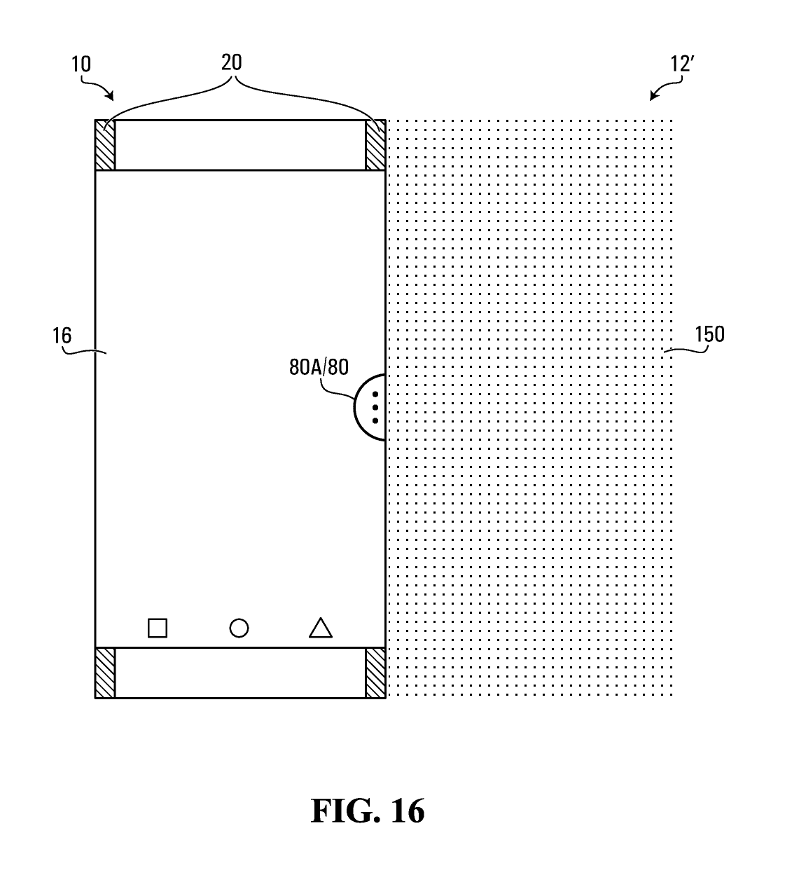

FIG. 16 is a plan view of the electronic devices of FIG. 15 mechanically joined. As illustrated device 10 has been connected with device 12′ at mounting location 151 by way of magnetic connectors 20. Upon detecting that it has been connected with device 12′, device 12 displays indicator 80A. As device 12′ lacks a display, indicator 80A alone forms button 80.

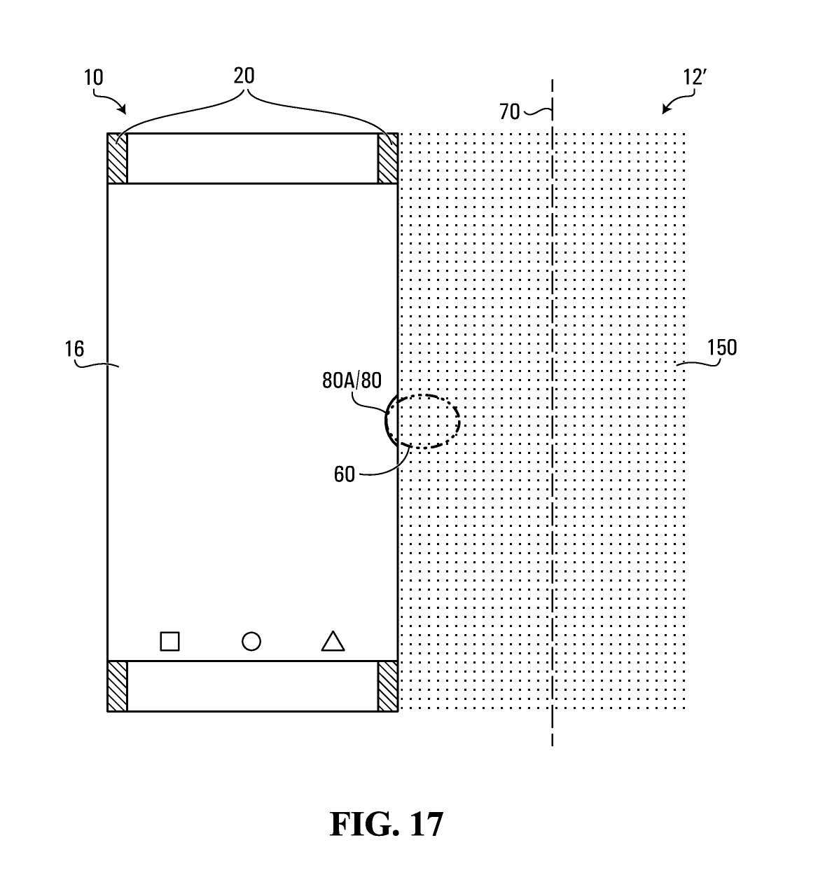

As depicted in FIG. 17, a gesture may be performed involving device 12′ and device 10 docked thereto.

As illustrated, gesture 60 begins near the right edge of device 10, i.e. at the initial position of button 80.

Optionally, the gesture may also begin on touch sensitive region 150 adjacent to button 80 such as where notionally an indicator matching indicator 80B would have been displayed if touch sensitive surface 150 was a display, i.e. as would form, for example, a symmetrical button 80.

Gesture 60 then progresses across touch sensitive region 150 of device 12′. During the gesture, the depiction of indicator 80A on device 10 reflects button 80 being dragged rightward. Notably, as illustrated, only the portion of button 80 that is notionally on display 16 is displayed, device 12′ having no display Button 80 will thus no longer be visible once it is dragged sufficiently rightward so as to be notionally entirely within touch sensitive region 150.

Once gesture 60 extends past confirmation threshold 70, device 12′ may process the request from device 10 in manners described above.

Of course, variations are possible. For example, multiple confirmation thresholds may be employed despite device 12′ lacking a display using techniques such as, for example, those described above.

Confirmation threshold 70 is illustrated as a stippled line showing a position on touch sensitive region 150. As illustrated, this is merely for the purposes of illustration. However, in some embodiments, confirmation threshold may be marked on touch sensitive region 150 such as, for example, by a printed or silk screened line or marks.

Techniques such as those described above may also be applied where the requesting device has no display.

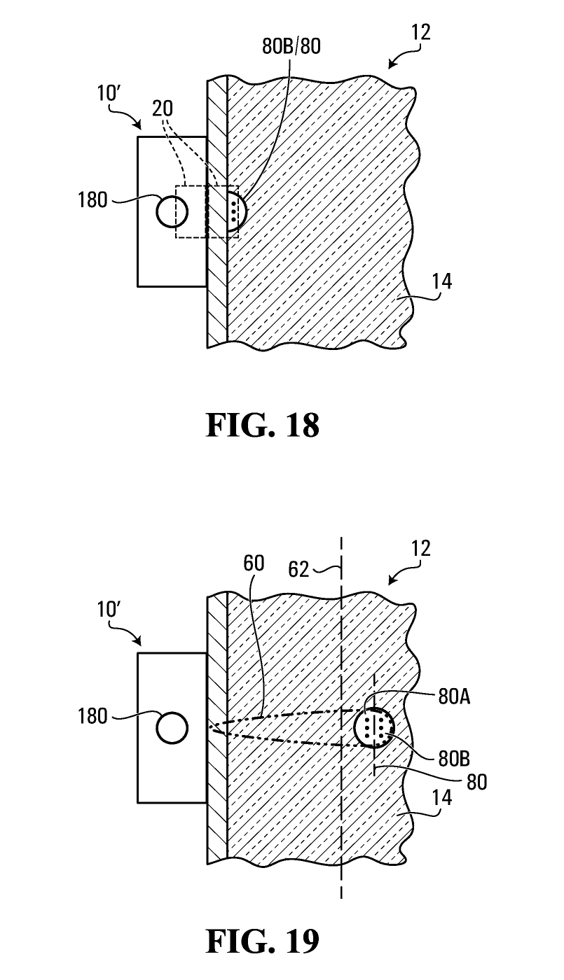

FIG. 18 shows a portion of electronic device 12 mechanically connected to a non-touch sensitive electronic device 10′.

Device 10′ is equipped with one or more magnetic connectors 20.

Device 10′ also includes a button 180. Button 180 may be, for example, a mechanical switch, a capacitive button, etc.

As illustrated, device 10 has been connected with device 12 by way their respective magnetic connectors 20.

Upon detecting that it has been connected with device 12′, device 12 displays indicator 80B using touch screen display 14. Indicator 80B is the visible portion of a button 80. As device 12′ lacks a display, indicator 80B solely forms button 80.

FIG. 19 is a further view of the electronic devices of FIG. 18, illustrating an interaction gesture.

A user may initiate a request at device 10′ by pressing button 180. The user then continues the request by a gesture 60 that extends rightwards across touch screen 14. During the gesture, the depiction of indicator 80B on device 12 reflects button 80 being dragged rightward. Notably, as illustrated, only the portion of button 80 that is notionally on display 14 is displayed; device 10′ having no display. As illustrated, as button 80 moves rightward, a second portion, indicator 80A is displayed that then also forms part of button 80.

Once gesture 60 extends past confirmation threshold 62, device 12 processes the request from device 10′, e.g. to grant or deny access to some or all of the requested resources etc. As described above, device 12 may also display a confirmation GUI, etc.

In some embodiments, devices without a display may not be equipped with a button for initiating an interaction. Alternatively, devices equipped with a button may not use it for that purpose. In such cases, the gesture on the device having a display may be used alone. This may then be processed in manners akin to those described above where a user fails to swipe across the screens of both devices where both are touch sensitive.

Notably, the above embodiments have been described with devices, such as the requesting and responding device, devices having displays, and devices not equipped with a touch sensitive region being in particular relative positions. Of course, this is by way of illustration only and is in no way limiting. The devices may, for example, be rotated into various positions. Similarly, gestures need not proceed left-to-right only or even only left-to-right or right-to-left. For example, where the devices are placed with one above the other, gestures may be, in effect, vertical rather than horizontal.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

What is claimed is:

1. A method comprising:
at a first electronic device comprising a plurality of connectors:
detecting that at least one connector of a second electronic device has been connected to at least one of the plurality of connectors of the first electronic device;
determining that the second electronic device is in an identified position proximate said first electronic device, the identified position being one of a plurality of possible positions for connecting with the first electronic device, the possible positions being defined by the plurality of connectors of the first device;
detecting at said first electronic device, a gesture on a sensing surface of said first device, said gesture comprising a swipe between a first position proximate said second electronic device and a second position,
detecting said swipe extending across a confirmation boundary on said sensing surface; and
in response to said detecting said swipe extending across said confirmation boundary, providing an indication confirming an inferred gesture across said first and second device.

2. The method of claim 1, wherein said swipe traverses said first position and continues to at least said second position.

3. The method of claim 1, wherein said confirmation threshold is a line.

4. The method of claim 1, wherein said confirmation threshold is an arc.

5. The method of claim 1 wherein said surface is a touch-screen display, the method further comprising:
displaying, on said touch-screen display, an image denoting a region of said surface proximate said second electronic device; and,
wherein said first position is in said region.

6. The method of claim 5 further comprising:
during said detecting of said gesture, updating the image displayed by said touch screen display so that said displayed image tracks said path across said surface.

7. The method of claim 5 wherein said second electronic device comprises a display, and wherein in said identified position said display of said second electronic device is adjacent said touch-screen display of said first electronic device, and wherein said displayed image is a first part of a button, the method further comprising:
sending a communication to said second electronic device to display a second part of said button positioned so that an entirety said button appears to straddle the displays.

8. The method of claim 7 further comprising:
during said detecting of said touch gesture:
sending communications to said second electronic device to update said displayed second part of said button; and,
updating the image displayed by said touch-screen display of said first electronic device;
so that said button appears to track said path across said displays.

9. The method of claim 1 wherein said plurality of connectors of the first electronic device and said at least one connector of the second electronic device each comprise a magnetic connector and wherein detecting that said second electronic device has been placed in an identified position proximate said first electronic device comprises detecting a coupling of said magnetic connectors.

10. The method of claim 1 further comprising:
receiving a communication from said second electronic device requesting access to one or more resources of said first electronic device; and
and further comprising, in response to said detecting said swipe extending across said confirmation boundary granting said second electronic device access to some or all of said one or more resources.

11. The method of claim 10 further comprising:
in response to said detecting said swipe extending across said confirmation boundary:
presenting one or more of the requested resources for confirmation;
receiving an indication confirming access should be granted to at least one of the requested resources;
granting said second electronic device access to said at least one of the requested resources.

12. The method of claim 1 wherein said providing an indication of said inferred gesture comprises sending a communication to said second electronic device to retrieve one or more requests for access to resources.

13. The method of claim 1 further wherein said path across said surface also traverses a second confirmation boundary on said surface, and wherein said indication further indicates that more intrusive access is intended than would be indicated by a traversal of only the first confirmation threshold.

14. The method of claim 1, wherein said identified position is a mounting location on said first electronic device.

15. The method of claim 14, wherein said mounting location comprises one or more magnetic connectors of said plurality of connectors and wherein said at least one connector comprises a further magnetic connector wherein detecting that said second electronic is in said identified position comprises detecting a coupling between said further magnetic connector and at least one of said one or more magnetic connectors.

16. A non-transitory computer readable medium storing instructions that when executed by a processor of a first electronic device comprising a plurality of connectors, cause said device to:
detect that at least one connector of a second electronic device has been connected to at least one of the plurality of connectors of the first electronic device;
determine that the second electronic device is in an identified position proximate said first electronic device, the identified position being one of a plurality of possible positions for connecting with the first electronic device, the possible positions being defined by the plurality of connectors of the first device;
detect at said first electronic device, a gesture on a sensing surface of said first device, said gesture comprising a swipe between a first position proximate said second electronic device and a second position,
detect said swipe extending across a confirmation boundary on said sensing surface; and
in response to detecting said swipe extending across said confirmation boundary, provide an indication confirming an inferred gesture across said first and second device.

17. An electronic device comprising:
a touch-sensitive surface;
a processor in communication with said touch-sensitive surface;
a plurality of connectors;
a non-transitory computer-readable medium coupled to the processor and storing instructions that when executed by said processor cause said device to:
detect that at least one connector of a second electronic device has been connected to at least one of the plurality of connectors of the first electronic device;
determine that the second electronic device is in an identified position proximate said first electronic device, the identified position being one of a plurality of possible positions for connecting with the first electronic device, the possible positions being defined by the plurality of connectors of the first device;
detect at said first electronic device, a gesture on a sensing surface of said first device, said gesture comprising a swipe between a first position proximate said second electronic device and a second position,
detect said swipe extending across a confirmation boundary on said sensing surface; and
in response to detecting said swipe extending across said confirmation boundary, provide an indication confirming an inferred gesture across said first and second device.
